(19) United States
(12) Patent Application Publication
(10) Pub. No.: US 2005/0073714 A1
(43) Pub. Date: Apr. 7, 2005

(54) Remote output device control program, computer readable recording medium containing the remote output device control program, and remote output device

(75) Inventor: Shinji Makishima, Tokyo (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/747,121

(22) Filed: Dec. 30, 2003

(30) Foreign Application Priority Data
Oct. 1, 2003 (JP) 2003-343556

(51) Int. Cl. G06F 15/00

(52) U.S. Cl. 358/1.15; 358/1.9

(57) ABSTRACT

A remote output device control program allows a remote output device to implement functions, in which the remote output device performs printing of print information from an information storage server on a network by a printing device, the server storing the print information upon a user's request for storage, wherein the functions include a print control function that controls printing according to printing attribute information which is set for the printing device, an information communication function that receives the print information and printing attribute information for the print information through a network, an operation display function that receives printing attribute information which is input by the user, while displaying printing attribute information which can be set by the print control function, and a printing setting function that changes the printing attribute information for the received print information to the printing attribute information input by the user.

### BACKGROUND OF THE INVENTION

1. Field of the Invention

The present invention relates to a remote output device control program, a computer readable recording medium that contains the remote output device control program, and a remote output device.

For example, the invention can be applied to: a remote output device (a multimedia KIOSK terminal (MMK) for example) installed in a convenience store or the like that obtains information stored by a data storage server and performs printing by a printing device connected to the remote output device; a program which is installed on the remote output device; and a recording medium which is readable by a computer that contains the program.

2. Description of the Related Art

Various services have been developed with network technology using websites that present users information which is stored in information storage servers on networks, with remote output devices (MMK terminals for example) which are installed in convenience stores, railway stations, hotels, and so on.

Japanese Unexamined Patent Application No. 2002-328978 discloses a travel service system in which a storage server allocates a storage area to a traveler for a certain period and stores travel guide information, travel schedules, and other information, and travelers obtain various stored information during a travel, using remote output devices in convenience stores or the like, and print the information by printing devices.

One of the above described services using websites is a print network system in which information storage servers obtain and store file information which users or people concerned have requested to register, then the users obtain the stored file information by remote output devices installed in convenience stores and so on, and print out the file information by printing devices connected to the remote output devices.

In the case that users print file information in a print network system or in the system disclosed in the above patent document, remote output devices are provided with a printer driver which controls a printing device and recognize printing attribute information included in advance in the file information, thereby determining the number of print copies, color/monochrome setting, and other printing attributes.

However, for increasing system user satisfaction, it is desirable that there is a possibility to change the settings of printing attributes in response to a request by a user.

For example, even when a user desires to print a plurality of copies, if the number of copies is set to one in the printing attribute information, only one copy can be printed by a file information obtaining process and printing instruction process each time. Therefore, to carry out printing in a desired number, it is necessary to perform the file information obtaining process and the printing instruction process for the number of times according to the desired number of copies.

Further, when some problem has occurred with a printing device connected to a remote output device, it is desirable that the event is displayed.

For example, despite the case that there is some problem with a printing device, a user obtains file information, using a remote output device, and at the time of printing thereafter, the user notices the fact that the printing device has some problem and cannot perform printing. This will cause the user to not only suffer from lost time, but also bear the additional economic cost of obtaining the information.

### SUMMARY OF THE INVENTION

Accordingly, it is an object of the present invention to provide a remote output device control program that can improve the satisfaction level of users and enables efficient system use, a computer readable recording medium containing the remote output device control program, and a remote output device.

To attain the above object, in a first aspect of the invention, there is provided a remote output device control program that allows a remote output device to implement functions, in which the remote output device obtains print information from an information storage server on a network, the server storing the print information upon a user's request for storage, and performs printing by a printing device connected thereto, the functions including: a print control function that controls printing, according to printing attribute information which is set for the printing device; an information communication function that receives the print information and the printing attribute information for the print information through a network; an operation display function that receives printing attribute information which is input by the user, while displaying printing attribute information which can be set by the print control function; and a printing attribute setting function that changes the printing attribute information for the received print information to the printing attribute information by the user which the operation display function has received.

Further, to attain the above object, in a second aspect of the invention, a computer readable recording medium that contains a remote output device control program according to the first aspect of the invention is provided.

Still further, to attain the above object, in a third aspect of the invention, there is provided a remote output device that obtains print information from an information storage server on a network, the information storage server storing the print information upon a user's request for storage, and performs printing by a printing device connected to the remote output device, the remote output device comprising: a print control unit that controls printing, according to printing attribute information which is set for the printing device; an information communication unit that receives the print information and the printing attribute information for the print information through the network; an operation display unit that receives printing attribute information which is input by the user, while displaying printing attribute information which can be set by the printing control unit; and a printing attribute setting unit that changes the printing attribute information for the received print information to the printing attribute information by the user.

As described above, with a remote output device control program, a computer readable recording medium containing the remote output device control program, and a remote output device according to the invention, in printing according to file information (print information) received from an information storage server through a network, it is possible to perform print setting, data editing, print preview, displaying an error in a printing device, and the like.

### BRIEF DESCRIPTION OF THE DRAWINGS

FIG. 1 is a diagram illustrating the functions of an MMK terminal according to an embodiment;

FIG. 2 is a diagram showing the entire configuration of a print network system 1 according to the embodiment;

FIG. 3 is a diagram illustrating the functions of an information storage server 400 according to the embodiment;

FIG. 4 is an example of information managed by an individual information database 405a according to the embodiment;

FIG. 5 is an example of information managed by a print setting database 405b according to the embodiment;

FIG. 6 is a flowchart showing the entire operation of a printing process according to the embodiment;

FIG. 7 is a diagram illustrating a print edit menu screen according to the embodiment;

FIG. 8 is a flowchart showing a print setting operation according to the embodiment;

FIG. 9 is a diagram illustrating an example of a print setting screen according to the embodiment;

FIG. 10 is a flowchart showing a data editing operation according to the embodiment;

FIG. 11 is a diagram illustrating an example of a data editing screen according to the embodiment;

FIG. 12 is a flowchart showing a print preview operation according to the embodiment;

FIG. 13 is a diagram illustrating a print preview screen according to the embodiment;

FIG. 14 is a flowchart of an error detection display operation according to the embodiment;

FIG. 15 is a diagram showing the function routine of a print setting function according to the embodiment; and

FIG. 16 is a diagram illustrating the function routine of a data editing function according to the embodiment.

### DESCRIPTION OF THE PREFERRED EMBODIMENTS

A remote output device control program, a computer readable recording medium that contains the remote output device control program, and a remote output device according to the invention will be described below with reference to the attached drawings.

A. Embodiment

In the present embodiment, the case that a remote output device control program and a computer readable recording medium that contains the remote output device control program are implemented, being installed on a remote output device (MMK terminal for example) of a print network system, will be described.

A-1 Configuration of Embodiment

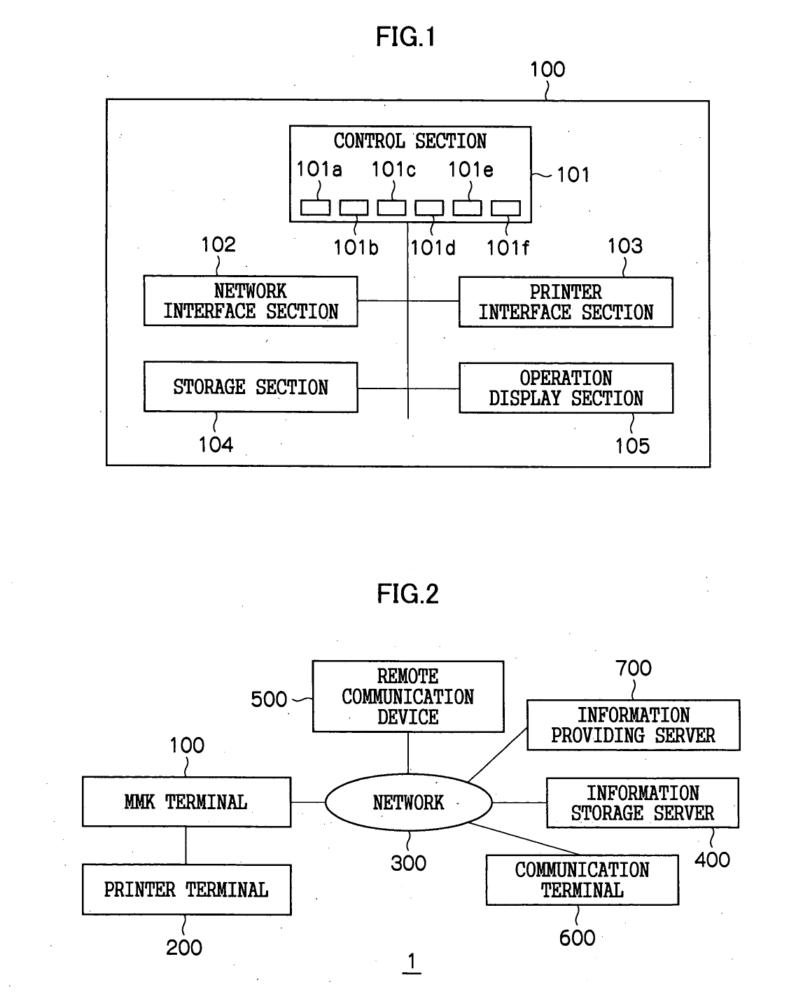

FIG. 2 shows the entire configuration of the print network system according to the embodiment.

A print network system 1 according to the embodiment comprises, as shown in FIG. 2, an MMK terminal (remote output terminal) 100, an information storage server 400, an information providing server 700, a remote communication device 500, and a portable communication terminal 600, which are connectable to a network 300.

Although FIG. 2 shows that the respective elements are connected through the same network 300, networking associated with connection between two elements may be implemented by a combination of a plurality of networks depending on the communication between the two elements. Further, although in FIG. 2, each element is shown in a single quantity, a plural quantity is also allowed.

The MKK terminal 100 is a remote output device which is installed, for example, in a convenience store, a railway station, a hotel, or the like, wherein a KIOSK terminal and a multimedia terminal are examples.

The MKK terminal 100 makes a call request to the information storage server 400 and obtains stored file information and printing attribute information with regard to printing attribute settings of file information, wherein the printing attribute settings have been set at registration. The MMK terminal 100 controls a printing device 200 connected thereto such that the printer 200 prints the obtained file information with the printing attributes included in the printing attribute information or printing attributes which are set by user operations.

Although in the present embodiment, printing control is described such that a single MMK terminal 100 controls printing of a single printing device 200, a single MMK terminal may control printing of a plurality of printing devices 200. Also, a plurality of MMK terminals 100 may control printing of a single common printing device 200.

The printer 200 is, for example, a printer or a device having printing functions (for example, a FAX, a copy machine, a combined machine) which is installed in a convenience store, a railway station, a hotel, or the like. The printer 200 prints file information (also referred to as ‘print information’) from the MMK terminal 100 under printing control by the MMK terminal 100.

Although in the present embodiment, it is described that the MMK terminal 100 and the printing device 200 are different devices, the MMK terminal 100 may integrate printing functions.

The remote communication device 500 is a communication terminal (a personal computer for example) that the user operates. The remote communication device 500 instructs the information storage server 400 to register (or store) file information (print information) to be printed at the MMK terminal 100.

The portable communication terminal 600 is a portable type of communication terminal operated by the user, and is, for example, a portable phone, a PDA, a PHS terminal, or the like having browser functions. The portable communication terminal 600 instructs the information storage server 400 to register (or store) file information to be printed at the MMK terminal 100.

The remote communication device 500 and the portable communication terminal 600 are examples of communication terminals that instruct the information storage server 400 to register file information, and various types of communication devices which can instruct the information storage server 400 to register (or store) file information can be applied.

The information storage server 400 allocates a storage area to each user, and stores file information in the storage areas. The information storage server 400 stores file information requested to be registered upon a request for registration from the remote communication device 500 or the portable communication terminal 600.

The information storage server 400 may store file information attached to an electronic mail received from the remote communication device 500 or the portable communication terminal 600, or may store content information which the information providing server 700 connectable to the network 300 provides. For example, in the case of storing content information on the information providing server 700, upon a request for registration, the information storage server 400 may receive the URL of the content information to be stored, from the remote communication terminal 500 or the portable communication terminal 600 by a user's operation, obtain the content information by tracing the URL, and store the content information.

Upon receipt of a call request from the MMK terminal 100, the information storage server 400 transmits the file information stored in the storage area, corresponding to the user, to the MMK terminal 100.

Thus, even away from home, the user can use the MMK terminal 100 so that the user can obtain the file information in the storage area of the user and further print out the file information by the printing device 200.

The information storage server 400 is also a server which totally manages the services associated with the print network system including a user authentication function, a file information storage management function, a user usage history management function, an accounting function for charging users, and a users' usage status management function.

The information providing server 700 is, for example, a content server which stores various information. When the user has requested the information storage server 400 to perform registration, the information providing server 700 provides the information storage server 400 with the information to be stored upon a request by the information storage server 400.

Next, the functions of the MKK terminal 100 will be described in detail. FIG. 1 is a block diagram showing the internal configuration of the MKK terminal 100. The MMK terminal 100 comprises a control section 101, a network interface section 102, a printer interface section 103, a HDD 104, and an operation display section 105. The internal configuration of the MKK terminal 100 corresponds to an existing remote output device.

The functions of the MMK terminal 100 described below can be implemented by installing respective programs which execute the functions, through a recording medium containing the programs or the network, and executed by the control section 101.

The functions of the MMK terminal 100 can be implemented by providing a recording medium that contains the respective programs to execute the functions, and is readable by the control section 101.

In FIG. 1, the control section 101 includes, for example, a CPU, a ROM, a RAM, software to be executed by the CPU, and others.

The control section 101 comprises a print control function 101a, a print setting function 101b for print information, a data edit function 101c for print information data, a print preview display function 101d, the print preview being according to the print information data, a print copy quantity counting function 101e to be used at the time of printing, and an error detection display function 101f, the error being in the printing device 200.

The print control function 101a is a printer driver for print control of the printing device 200, and is stored as software. The print control function 101a comprises, in advance, types and ranges which are possible in print setting corresponding to the printing device 200, and controls printing of the printing device 200, within the types and the ranges which can be set for printing, according to print settings recognized from printing attribute information received together with the file information or print settings set by the user.

During the print setting operation mode for the print information (file information), the print setting function 101a displays the types and the ranges which are provided in the print control function 101a and are possible in print setting, receives the print settings set by the user, and prints the print information with the print settings set by the user.

With the print settings by the user, the print setting function 110a sets print settings which are adjusted from or added to the print settings of the printing attribute information received together with the file information.

Thus, the print settings can be changed from the print settings at registration (that are, print settings stored in a print setting database 405b described later) to different print settings, making it possible to print the print information with print settings desired by the user.

Print setting is carried out with the setting conditions of the printing control integrated in the print control function 101a, allowing color printing, monochrome printing, 2-in-1 printing, 4-in-1 printing, double-sided printing, single-sided printing, sheet size setting, magnification setting, density setting of setting color brightness and print density, and the like. Print setting can change a plurality of types of settings.

The data edit function 101c performs editing of print information data by a user operation during a data editing operation mode that edits data of print information. Editing of print information data performed by the data editing function 101c includes, for example, a trimming function that deletes unnecessary parts out of the print information, a masking function that protects parts which need protection from modification, and a watermark function that attaches a watermark on sheets. The data editing function 101c can perform a plurality of types of data editing.

To perform data editing, it is desirable that a print image according to print information data at the time before, during, or after data editing, is displayed on the operation display section 105. Thus, the user can carry out data editing correctly and easily.

When the user performs trimming for example, the data editing function 101c deletes print information data of a part designated by the operation display section 105. Print information performed with trimming and data editing is temporarily stored in the storage section 104. Further, in the case of performing masking for example, a part designated by the user is processed into data which shows masking, and print information processed with masking is stored in the storage section 104. In the case of attaching a watermark, a design of the watermark which is set in advance or a design of a watermark which is designated by the user is retrieved. Then, according to the size and the density of color of the watermark and the attaching position designated by the user, the data editing function 101c performs attaching of the watermark. The print information stuck with the watermark is stored in the storage section 104.

The print preview function 101d displays a print image according to the print information data stored in the storage section 104, on the operation display section 105 at the time of executing printing. The print image displayed by the print preview function 101d can be either the print image of the print information before data editing or the print image of the print information after data editing. Also, the print preview function 101d may be used to display a print preview in order to designate or specify a data editing part in data editing.

At the time of printing by the printing device 200, the print copy quantity counting function 101e counts the current number of print copies for the number of print copies which is set by the user or the number of print copies which is included in advance in the file information, and displays the current number of print copies on the operation display section 105.

The error detection display function 101f detects an error in the printing device 200 by receiving, from the printing device 200, error information that has been detected in the printing device 200, and displays the fact that there is an error in the printing device 200, on the operation display section 105.

The network interface section 102 is a communication interface section which is connected to the network 300 and executes a communication process associated with transmitting and receiving of data. When the network interface section 102 has received file information, the network interface section 102 provides the received file information to the storage section 104 to have the storage section 104 store the received file information.

The printer interface section 103 is a communication interface section with the accommodated printing device 200. The printer interface section 103 transmits print information (file information) data which is retrieved by the print control function 101a from the storage section 104 and is data edited, to the printing device 200, and has the printing device 200 print the print information, according to print settings by the print setting function 101b. The printer interface section 103 can employ, for example, an interface according to SCSI (Small Computer System Interface) specifications.

The storage section 104 is an external storage device that temporarily stores file information obtained from the information storage server 400 in response to a user operation. Also, the storage section 104 temporarily stores print information (file information) edited by a user operation. At the time of printing, the storage section 104 provides the printing device 200 with the stored print information through the printer interface section 103 under the control of the control section 101.

The operation display section 105 is formed of, for example, an input section configured by hard keys such as keyboards or tenkeys which are operated by the user and a display section such as a liquid crystal display screen. The operation display section 105 is the interface between the MMK terminal 100 and the user. The operation display section 105, for example, displays operation guides, print previews according to print information, requests/questions/confirmation results for print setting or editing of print information data, error detection information of the printing device 200, and the like, and also receives selections/requests by the user to provide the selections/requests to the control section 101.

The operation display section 105 may be, for example, an integrated type such as a liquid crystal operation display section with an integrated touch panel, or may be formed as separating into user operation section and display section.

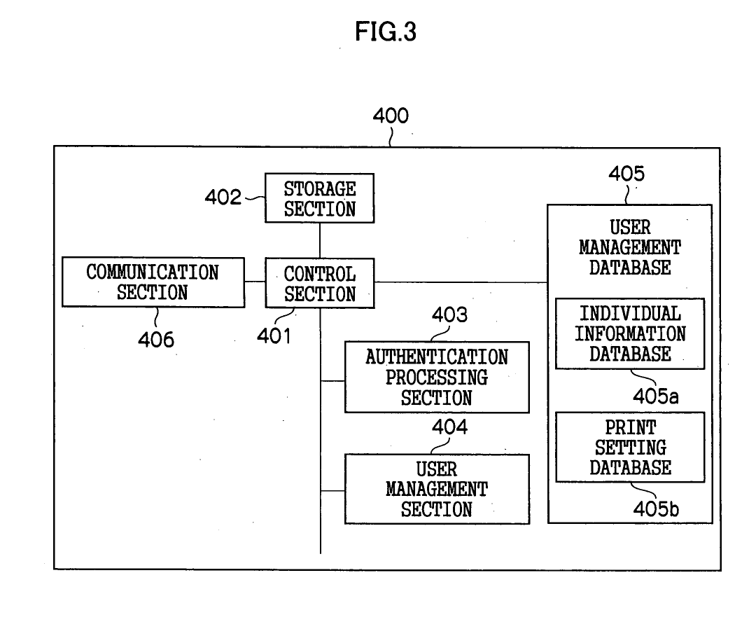

Next, the internal configuration and functions of the information storage server 400 will be described with reference to FIG. 3. As shown in FIG. 3, the information storage server 400 comprises a control section 401 that controls the functions of the information storage server 400, a storage section 402, a user management database 405, and a communication section 406 which is the communication interface with the network 300.

The storage section 402 is, for example, an external storage section, which is an auxiliary storage section for the control section 401.

The control section 401 comprises, for example, a CPU, a ROM, a RAM, and software to be executed by the CPU. The control section 401 comprises an authentication processing section 403 having a user authentication function and a user management section 404 which includes a file information storage management function, a user usage history management function, an accounting function for charging users, a users' usage status management function, and the like, and performs overall management of the services associated with the print network system.

Upon a request for registration of file information, the authentication processing section 403 performs an authentication process of the user, according to individual identification information and a password received from the remote communication device 500 or the portable communication terminal 600. This individual identification information is a user ID which is set so that the information storage server 400 identify the user from other users, and a password is decided by each individual user.

At the time of a request from the MMK terminal 100 for file information, the authentication processing section 403 performs the authentication process, according to authentication information for printing received from the MMK terminal 100. This authentication information for printing is decided at the time of registration of file information, and is information (ID information for printing) for authentication at the time of a request for the file information.

The user management section 404 carries out file information storage management, user usage history management, accounting management to charge users, users' usage status management, and the like, under the control of the control section 401.

The user management database 405 is a database that stores file information designated by the user from the remote communication device 500 or the portable communication terminal 600. The user management database 405 may change various stored information (for example, individual information, passwords, and information stored in the user management database 405, such as storage conditions) upon a request from the remote communication device 500, the portable communication terminal 600, or the MMK terminal 100.

The user management database 405 comprises an individual information database 405a and a print setting database 405b.

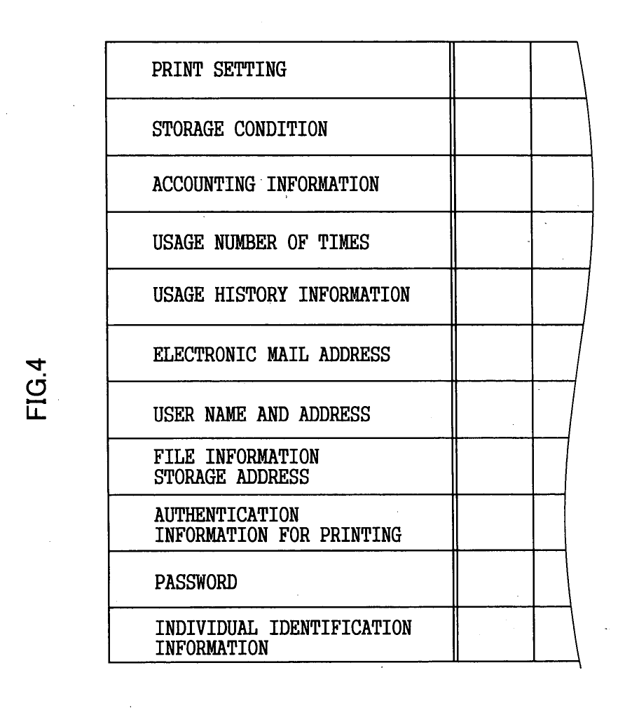

FIG. 4 shows an example of information managed by the individual information database 405a. The individual information database 405a manages individual identification information, passwords, authentication information for printing, file information storage addresses, names and addresses of users, electronic mail addresses, usage history information, the number of uses, accounting information, storage conditions, print settings, and other information.

The file information storage addresses are storage addresses in the storage area which stores file information designated by users. The usage history information is, for example, position information of MMK terminals 100 (for example, addresses of stores where MMK terminals 100 are installed) which users used in the past, the usage time period, types of images of file information registered in the past, and other historical information. The number of uses is the number of times users used the services in the past, such as the number of times of registration usage and the number of times of call usage of file information. The storage conditions are the storage capacity of the storage area allocated to the user at contract time, the storage period, the resolution level of file information at the time of printing, the usage charge for storing file information, the compression level of transmitted data at the time of transmitting the data to the MMK terminal 100 upon a request, and other conditions.

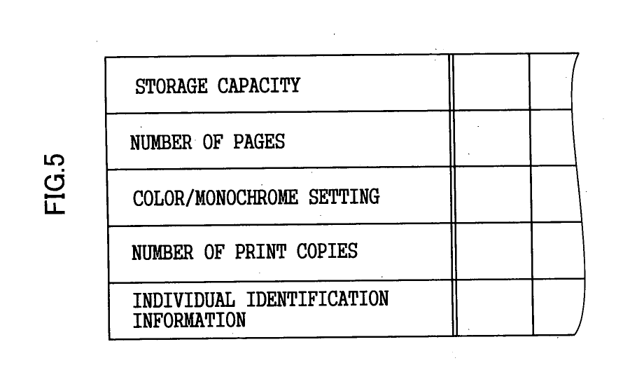

FIG. 5 shows an example of information managed by the print setting database 405b. The print setting database 405b manages information the user has set for printing conditions at the time of registration of file information.

The print setting database 405b manages information such as individual identification information, the number of print copies, color/monochrome setting, the number of pages, and the storage capacity. In addition to these, at the time of performing printing, the print setting database 405b may manage information such as, for example, 2-in-1 print setting, 4-in-1 print setting, double-sided print setting, single-sided print setting, magnification setting, and density setting.

The number of print copies is the number of copies for printing the file information at the time of performing printing, and the color/monochrome setting is setting information as to whether file information to be printed is printed in color or monochrome. The number of pages is that of file information to be printed. The storage capacity is that of stored file information.

A-2 Operation of Embodiment

Next, the operation in the present embodiment will be described with reference to the attached drawings. In the following, first, (1) the entire operation from the time when the user obtains file information from the information storage server 400, using the MMK terminal 100, until the time when the user prints the file information will be described.

Then, as specific operations associated with printing control of the file information, (2) print setting operation, (3) data editing operation, (4) print preview operation, and (5) printing device error detection display operation will be described.

A-2-1 Entire Operation of Print Execution

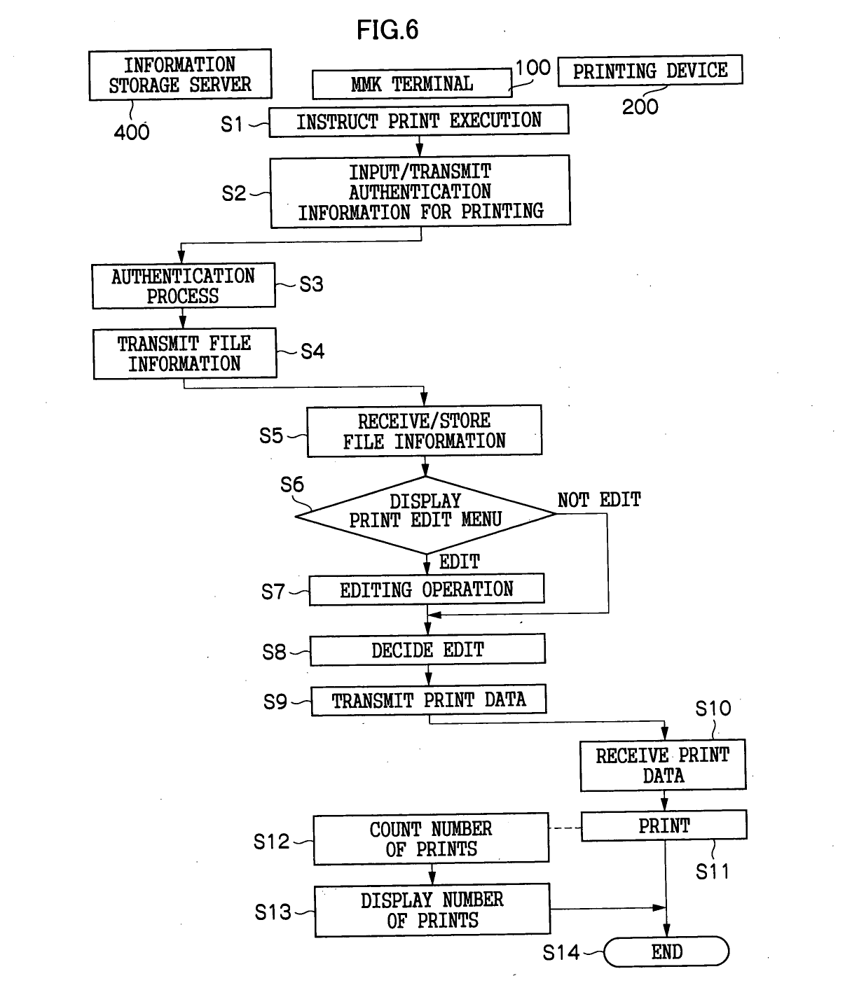

FIG. 6 shows a flowchart of the entire operation of print execution.

When the user obtains and prints the file information, print execution is instructed by a user's operation of an MMK terminal 100 installed in a convenience store or the like (S1). The print execution instruction is carried out, for example, in such a manner that a selection button which shows the print execution instruction is displayed on the operation display section 105 of the MMK terminal 100 and the user selects the selection button.

When the user has instructed print execution, the operation display section 105 of the MMK terminal 100 displays that input of authentication information for printing is required. At this time, in the authentication process for printing, which is executed on the side of the information storage server 400, in the case that information other than the authentication information for printing (for example, a password or individual authentication information) is needed, input of necessary information may be required.

If an input prompt for authentication for printing is displayed on the operation display section 105, authentication information for printing which is input by the user is received by the operation display section 105, and the authentication information for printing is transmitted to the information storage server 400 through the network interface section 102 under the control of the control section 101 (S2).

On the information storage server 400 which has received the authentication information for printing, the authentication processing section 403 performs the authentication process according to the received authentication information for printing (S3). If information other than the authentication information for printing is needed in the authentication process for printing, of course, the authentication process is performed according to all of this necessary information.

On the information storage server 400, if the result of authentication by the authentication processing section 403 is OK, corresponding file information which is stored by the information storage server 400 is transmitted to the MMK terminal 100 through the communication section 406 (S4).

If the authentication result by the authentication processing section 403 is invalid, file information is not transmitted from the information storage server 400, and information that the authentication result is invalid is transmitted to the MMK terminal 100. Upon receipt of this information, the fact that the authentication result is invalid is displayed on the operation display section 105 of the MMK terminal 100. At this time, a prompting for reinput of the authentication information for printing may be displayed to have the user perform a reinput process up to a certain number of times.

In the MMK terminal 100 having received the file information, the received file information is temporarily stored in the storage section 104 (S5). The file information transmitted from the information storage server 400 is transmitted, for example, in the PDF (Portable Document Format by Adobe) file format.

When the received file information has been stored in the storage section 104, a print edit menu is displayed on the operation display section 105 under the control of the control section 101 (S6).

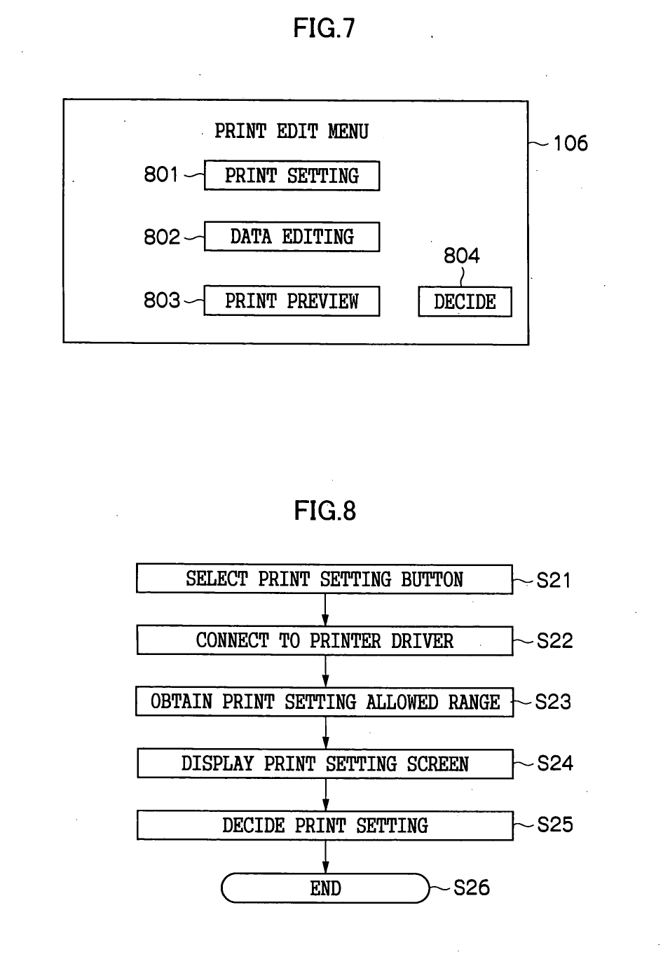

An example of the screen of this print edit menu is shown in FIG. 7. As shown in FIG. 7, the print edit menu screen displayed on the operation display section 105 displays a print setting button 801, a data editing button 802, a print preview button 803, and a set button 804.

The print setting button 801 is a button to start a print setting operation mode which allows the user to set print settings within the range possible for print control by the print driver section 105. Details of the print setting operation will be described later, but, if the user selects the print setting button 801, the user can set print settings such as the number of print copies, color/monochrome setting, 2-in-1 setting, 4-in-1 setting, single-sided print setting, double-sided print setting, sheet size setting, magnification setting, density setting, and so on.

The data editing button 802 is a button to start the data editing operation mode. Though details of the data editing operation will be described later, if the user selects the data editing button 802, the user can do trimming, masking, attaching of a watermark, or the like.

The print preview button 803 is a button to start the print preview operation mode. Though details of the print preview operation will be described later, if the user selects the print preview button 803, the user can display a print image according to print information data on the operation display section 105.

The set button 804 is a button to proceed to the next step, and is selected by the user in the case that the user does not do print setting or editing of print data, or after data editing.

When the user performs print setting, editing of the print information data, or the like, a selection button displayed on the operation display section 105 is selected as the user desires, then the operation mode desired by the user is started as instructed by the control section 101, and an editing operation is performed by the user (S7). This editing operation will be described later for each operation mode.

When the user does not perform print setting, editing of print information data, or the like, the set button 804 on the print edit menu screen is selected (S8), and the process is made to proceed to the next step S9 by the control section 101.

When the edit operation by the user is finished, the edited print information data is stored in the storage section 104. When the user performs printing of the print information, the set button displayed on the operation display section 105 is selected (S8), the print information data stored in the storage section 104 is transmitted to the printing device 200 through the printer interface section 103 under the control of the control section 101 (S9).

Printing is executed by the printing device 200 which has received the print information data from the MMK terminal 100, according to the received print information data (S11).

On the other hand, in the MMK terminal 100, the current number of printed print copies by the printing device 200 is counted by the print copy quantity counting function 101e under print control by the print control function 101a (S12).

The number of print copies counted by the print copy quantity counting function 101e is displayed on the operation display section 105 under the control of the control section 101 (S13). At this time, although the number of print copies displayed on the operation display section 105 may simply be the current number of printed print copies, the number of the remaining print copies for the number of print copies set by the user may be displayed instead, for example.

When the printing process of the number of print copies set for the print information data is completed by the printing device 200, the printing process of the file information is terminated (S14).

A-2-2 Print Setting Operation

Next, the print setting operation mode which is started by the user's selection of the print setting button 801 on the print edit menu screen in S6 in FIG. 6 will be described with reference to FIG. 8.

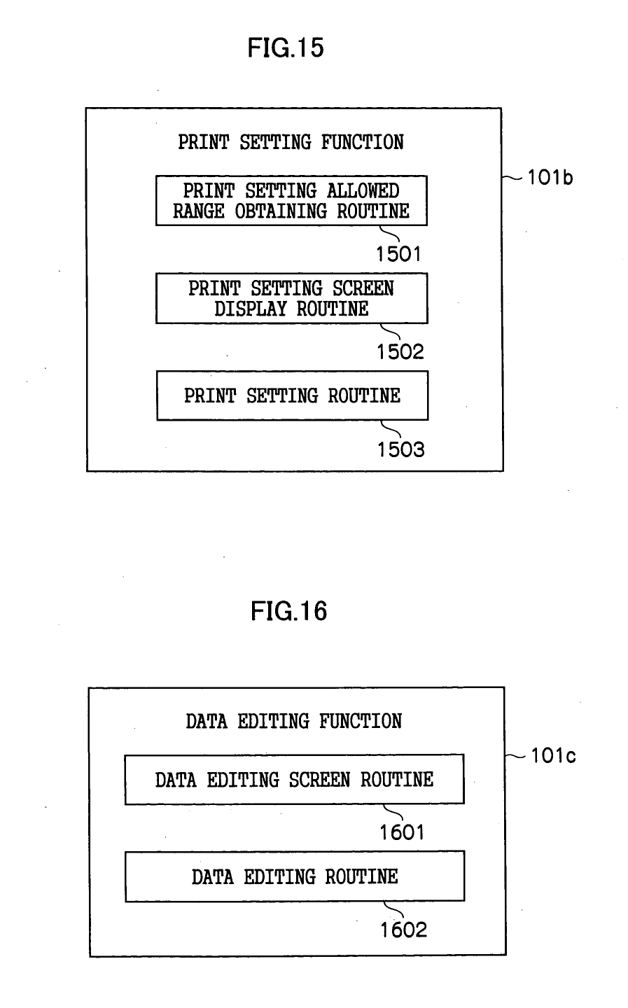

FIG. 15 illustrates the function routines of the print setting function 101b. As shown in FIG. 15, the function routines of the print setting function 101b include an allowed print setting range obtaining routine 1501, a print setting screen display routine 1502, and a print setting routine 1503.

In S6 in FIG. 6, if a print setting button 801 on the print edit menu screen is selected (S21), the print setting function 101b and the print control function 101a are connected under the control of the control section 101 (S22).

When the print setting function 101b is connected to the print control function 101a, the kinds and ranges of printing attributes which are set in advance in the print control function 101a and which can be set for the printing device 200 are provided to the print setting function 101b (S23).

When the kinds and ranges of printing attributes which can be set by the print control function 101a are provided to the print setting function 101b, a print setting screen according to the kinds and ranges of printing attributes which can be set is displayed on the operation display section 105 (S24).

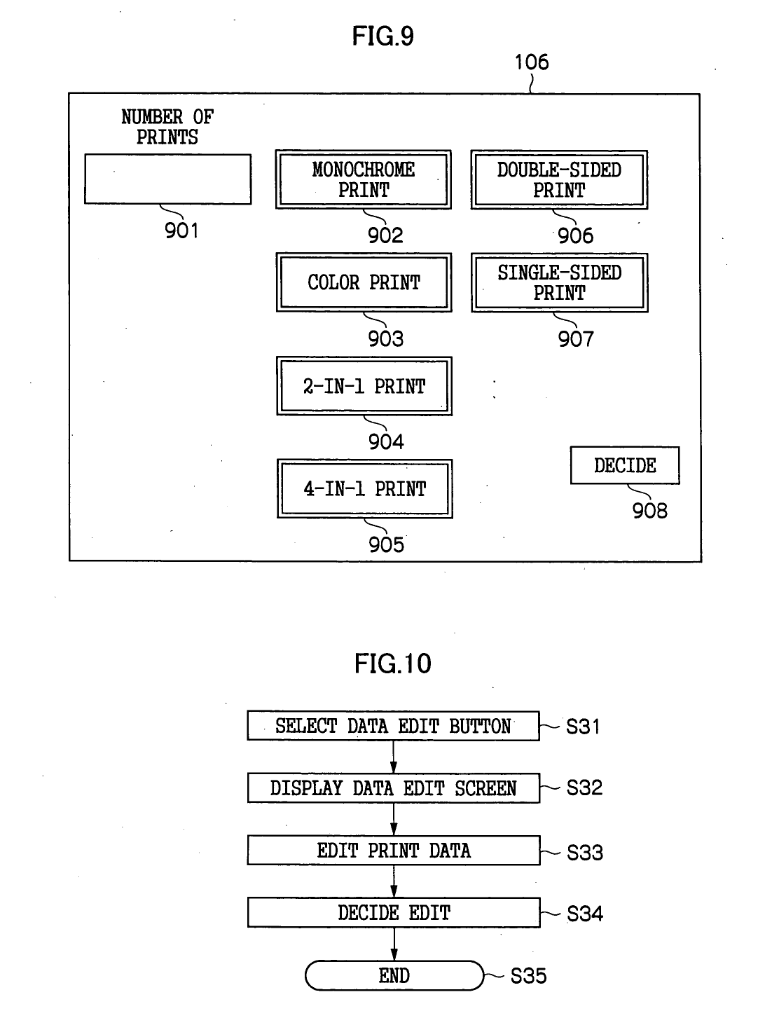

FIG. 9 shows an example of a print setting screen which is displayed on the operation display section 105. On the print setting screen, selection buttons which allow print setting are displayed, and for example, a print copy quantity designating section 901, a monochrome printing button 902, a color printing button 903, a 2-in-1 printing button 904, a 4-in-1 printing button 905, a double-sided printing button 906, a single-sided printing button 907, and a set button 908 are displayed.

The print copy quantity designating section 901, for example, allows textbox control, receives the number of print copies input by the user through the operation display section 105, and displays the number of copies.

The monochrome printing button 902, the color printing button 903, the 2-in-1 printing button 904, the 4-in-1 printing button 905, the double-sided printing button 906, the single-sided printing button 907, and the set button 908 allow, for example, button control which makes it possible to set printing attributes corresponding to the selection by the user.

As print setting other than described above, for example, a sheet selection button to set the print sheet size, a magnification button to set the printing magnification, a density button to set the brightness and the printing density, and the like, may be provided.

For example, if the monochrome printing button 902 is selected, it is possible to set printing such that the file information is printed in monochrome, and even when the image contained in the file information is in color, printing in monochrome is allowed by this setting.

When input associated with print setting is done by the user, the print setting function 101b receives the input to set the print settings (S25). At this time, the print attribute information that has been received together with the print information and stored in the print setting database 405b can be changed (including replacement, minor changes, and additions) to the printing attribute information selected this time by the user to set the print settings.

When print setting is terminated, the set button 908 is selected by the user to terminate the print setting operation mode (S26).

If the print setting button 801 is not selected by the user, printing is executed according to the print settings of the printing attribute information received together with the print information.

A-2-3 Data Editing Operation

Next, the data editing operation mode which is started by the user's selection of the data editing button 802 on the print edit menu screen in S6 in FIG. 6 will be described with reference to FIG. 10.

FIG. 16 describes the function routines of the data editing function 101c. As shown in FIG. 16, the function routines of the data editing function 101c include a data editing screen routine 1601 and a data editing routine 1602.

If the data editing button 802 is selected in S6 in FIG. 6 (S31), a data editing screen is displayed on the operation display section 105, according to the print information data that is stored in the storage section 104 (S32).

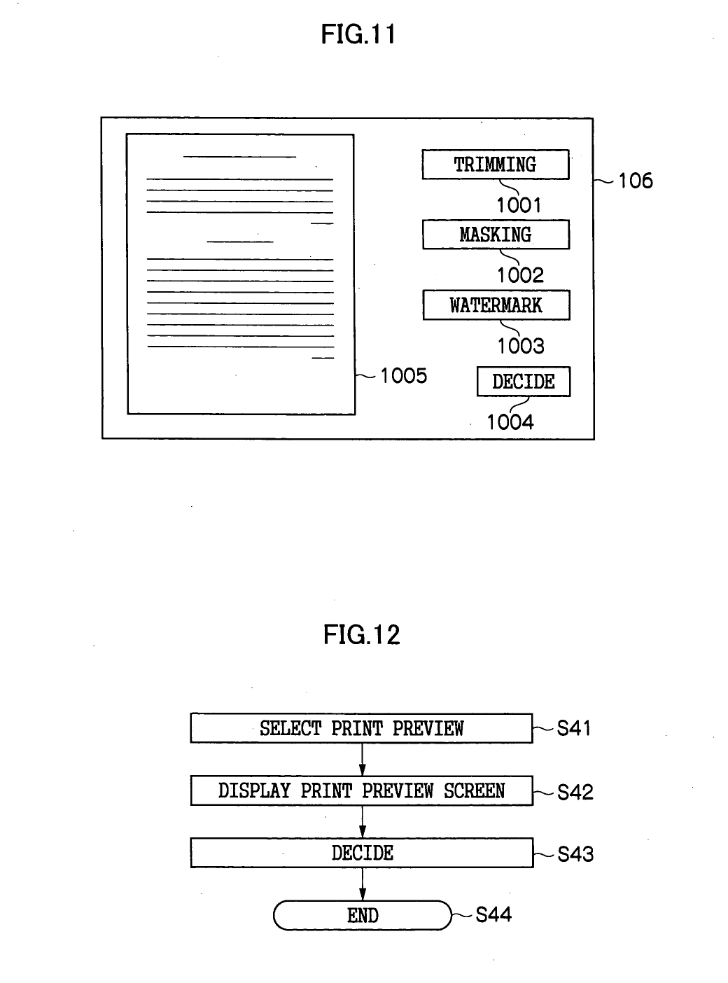

FIG. 11 shows an example of a data editing screen which is displayed on the operation display section 105. The data editing screen is a screen to edit print information data, and comprises, for example, a trimming button 1001, a masking button 1002, a watermark attaching button 1003, a set button 1004, and a print preview screen 1005.

If the data editing screen is displayed on the operation display section 105, a selection button that the user desires is selected, and the corresponding editing of the print information data is performed (S33).

For example, if the user selects the trimming button 1001, the user designates, with the operation display section 105 and on the print preview screen 1005, the start point and the end point of a part to be trimmed. Then, the data editing function 101c deletes the designated part.

Further, for example, if the user selects the masking button 1002, the user designates the start point and the end point on the print preview screen 1005, the same as the case of trimming, to designate a masking part (a part of the image not to be changed). Then, the data editing function 101c masks the designated part.

As editing of print information data other than described above, for example, character font setting, font color designation, rule line insertion, framing of the image, and the like may be provided.

When editing of the print information data by the user is completed, the print information whose data has been edited is stored in the storage section 104. Then, the set button 1004 is selected by the user (S34), and the editing operation of the print data is terminated (S35).

A-2-4 Print Preview Operation

Next, the print preview operation mode which is started by the user's selection of the print preview button 803 on the print edit menu screen in S6 in FIG. 6 will be described with reference to FIG. 12.

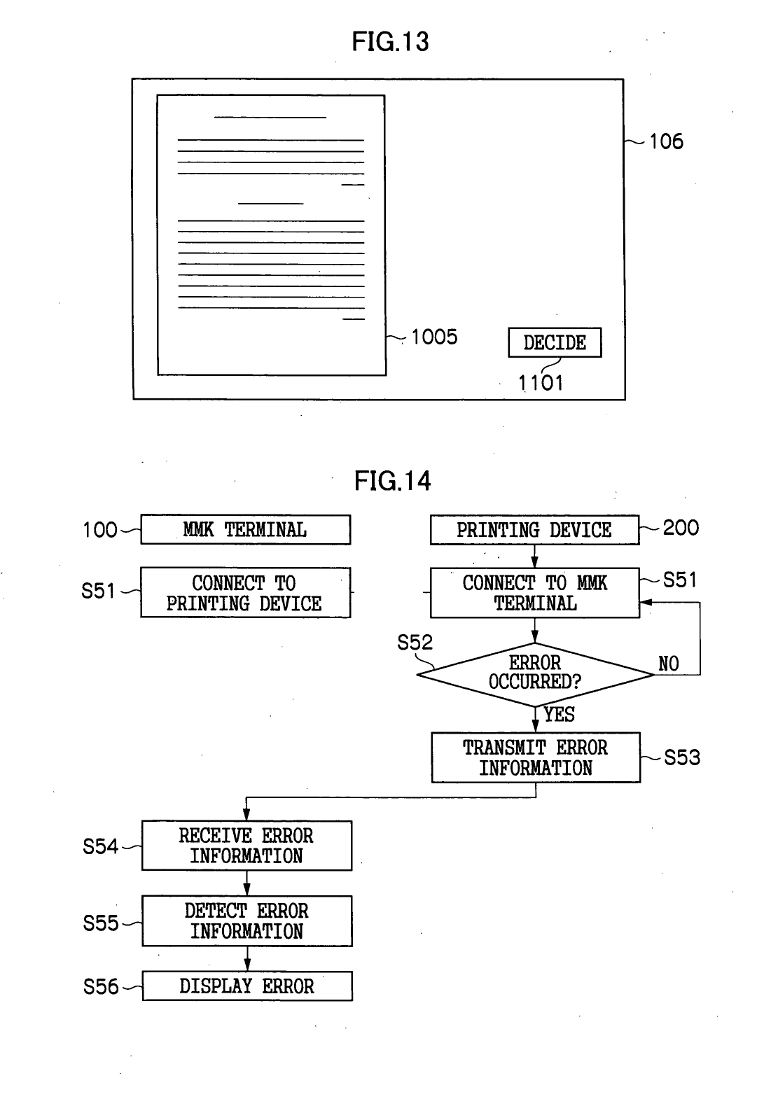

If the print preview button 803 is selected in S6 in FIG. 6 (S41), a print preview screen is displayed on the operation display section 105 under the control of the control section 101, according to the print information data stored in the storage section 104 (S42). FIG. 13 shows an example of a print preview screen displayed on the operation display section 105.

After the user sees the print preview screen 1005 and determines the print image, the set button 1101 is selected (S43), and the print preview operation is terminated (S44).

A-2-5 Print Device 200 Error Detection Display Operation

Next, the operation to detect an error in the printing device 200 and display that fact on the operation display section 105 will be described with reference to FIG. 14.

When the MMK terminal 100 and the printing device 200 are connected (S51), it is detected whether or not there is any error (S52) in the printing device 200. An error can occur, for example, in the case that a problem has occurred with feeding of original sheets by an automatic draft feeder (ADF) which is arranged in the printing device 200, in the case that no sheets are arranged, or in the case that the toner runs out.

If an error is detected in the printing device 200, error information is transmitted from the printing device 200 to the MMK terminal 100 (S53).

If no error is detected in the printing device 200, error information is not transmitted, the process returns to S51, and thus the printing device 200 remains in the state allowing printing. Error detection in the printing device 200 may be repeatedly monitored at predetermined intervals, or may be done at the time the user uses the MMK terminal 100.

If the MMK terminal 100 is supplied with the error information (S54), the error information is detected by an error detection section 112 (S55).

If the error detection section 112 detects the error information, the fact that there is error information is displayed on the operation display section 105 under the control of the control section 101 (S56).

With the display of the error information on the operation display section 105 of the MMK terminal 100, the user can know whether or not the printing device 200 is in the state allowing printing.

Thus, using an MMK terminal, a user can perform print setting, data editing, and so on, as the user desires, on file information registered upon a request by the user, wherein the file information is on the information storage server. Even in the case that an error has occurred to the printing device, as the error can be displayed in advance on the MMK terminal, it is possible for the user to perform a printing process smoothly.

Further, as it is possible to receive print information stored by the information storage server through the network, and set printing attributes at the time of printing of the print information on the side of the remote output device, the usage satisfaction level of users can be improved, and an efficient system use can be achieved.

B. Other Embodiments

B-1 In the above described embodiment, each operation mode is started from the print edit menu. However, in the operation of each operation mode, another operation mode may be started.

For example, when the print setting operation mode is in operation, the data edit button and the print preview button which change the mode to the print editing operation mode may be displayed on the print setting screen so that the user can select a selection button, and thus the control section 101 controls the process to start a corresponding operation mode.

B-2 In the above described embodiment, print setting and editing operation of print information data at the time of executing printing have been described. However, the print settings which are set by the user or the edited result of the print information data, which are performed after the user's print setting, data editing, or printing, may be registered on the information storage server 400 as newly specified values.

In this case, after print setting, data editing, or printing, a question as to whether the information on the resulting print settings and/or the edited result of the print information data is to be registered on the information storage server 400, is displayed on the operation display section 105, and upon a request by the user, information on the printing attributes and/or information on the result of editing the print information data is transmitted to the information storage server 400.

Further, according to the information received from the MMK terminal 100 on the printing attributes and/or the information received from the MMK terminal 100 on the result of editing of the print information data, the information storage server 400 updates the stored content of the print setting database 405b.

Still further, when the storage content of the print setting database 405b is updated on the information storage server 400, the information storage server 400 may transmit the fact that the storage content has been updated by electronic mail to the electronic mail address which is stored in the individual information database 405a.

1. A remote output device control program allowing a remote output device to implement functions, in which the remote output device obtains print information from an information storage server on a network, the server storing the print information upon a user's request for storage, and performs printing by a printing device connected thereto, the functions including:
a print control function that controls printing, according to printing attribute information which is set for the printing device;
an information communication function that receives the print information and printing attribute information for the print information through a network;
an operation display function that receives printing attribute information which is input by the user, while displaying printing attribute information which can be set by the print control function; and
a printing attribute setting function that changes the printing attribute information for the received print information to the printing attribute information by the user which the operation display function has received.

2. The remote output device control program according to claim 1, further allowing the remote output device to implement a print information data editing function that edits data of the received print information.

3. The remote output device control program according to claim 1, further allowing the remote output device to implement a print preview display function that displays a print preview by the operation display function, according to data of the print information.

4. The remote output device control program according to claim 2, further allowing the remote output device to implement a print preview display function that displays a print preview by the operation display function, according to data of the print information.

5. The remote output device control program according to claim 1, further allowing the remote output device to implement an error detection display function that receives error information on the printing device, the error information being detected by the printing device, and displays error content of the printing device according to the error information by the operation display function.

6. The remote output device control program according to claim 2, further allowing the remote output device to implement an error detection display function that receives error information on the printing device, the error information being detected by the printing device, and displays error content of the printing device according to the error information by the operation display function.

7. The remote output device control program according to claim 3, further allowing the remote output device to implement an error detection display function that receives error information on the printing device, the error information being detected by the printing device, and displays error content of the printing device according to the error data information by the operation display function.

8. A computer-readable recording medium that contains the remote output device control program according to claim 1.

9. A computer-readable recording medium that contains the remote output device control program according to claim 2.

10. A computer-readable recording medium that contains the remote output device control program according to claim 3.

11. A computer-readable recording medium that contains the remote output device control program according to claim 5.

12. A remote output device comprising:
an information communication section that receives, through a network, print information and printing attribute information for the print information from an information storage server on the network, the server storing the print information upon a user's request for storage;
a print control section that controls printing, according to printing attribute information which is set for a printing device connected thereto;
an operation display section that receives printing attribute information which is input by the user, while displaying printing attribute information which can be set by the print control section; and
a printing attribute setting section that changes the printing attribute information for the received print information to the printing attribute information by the user.

13. The remote output device according to claim 12, further comprising a data editing section that edits data of the received print information.

14. The remote output device according to claim 12, further comprising a print preview display section that displays a print preview on the operation display section, according to the data of the print information.

15. The remote output device according to claim 13, further comprising a print preview display section that displays a print preview on the operation display section, according to the data of the print information.

16. The remote output device according to claim 12, further comprising an error detection display section that receives error information on the printing device, the error information being detected by the printing device, and displays error content of the printing device according to the error information by the operation display section.

17. The remote output device according to claim 13, further comprising an error detection display section that receives error information on the printing device, the error information being detected by the printing device, and displays error content of the printing device according to the error information by the operation display section.

18. The remote output device according to claim 14, further comprising an error detection display section that receives error information on the printing device, the error information being detected by the printing device, and displays error content of the printing device according to the error information by the operation display section.

19. The remote output device according to claim 15, further comprising an error detection display section that receives error information on the printing device, the error information being detected by the printing device, and displays error content of the printing device according to the error information by the operation display section.
